(19) United States
(12) Patent Application Publication
(10) Pub. No.: US 2018/0209321 A1
(43) Pub. Date: Jul. 26, 2018

(54) EXHAUST PURIFICATION SYSTEM FOR INTERNAL COMBUSTION ENGINE

(71) Applicant: TOYOTA JIDOSHA KABUSHIKI KAISHA, Toyota-shi (JP)

(72) Inventor: Daichi IMAI, Sunto-gun (JP)

(73) Assignee: TOYOTA JIDOSHA KABUSHIKI KAISHA, Toyota-shi (JP)

(21) Appl. No.: 15/861,946

(22) Filed: Jan. 4, 2018

(30) Foreign Application Priority Data
Jan. 25, 2017 (JP) 2017-011308

(51) Int. Cl. F01N 9/00; F01N 3/10; B01D 53/94; B01J 21/04; B01J 23/02; F01N 3/08; F01N 3/023; B01J 38/12; B01J 38/02; B01J 23/96; B01J 23/58; B01J 23/42

(52) U.S. Cl. CPC F01N 9/002; F01N 2900/1602; B01D 53/9477; B01D 53/9495; B01J 21/04; B01J 23/02; B01D 53/944; F01N 3/085; F01N 3/023; B01J 38/12; B01J 38/02; B01J 23/96; B01J 23/58; B01J 23/42; B01D 2255/90; B01D 2255/915; B01D 2255/1021; B01D 2255/2042; F01N 3/106

(57) ABSTRACT

An exhaust purification system for an internal combustion engine provided with an SO_{X} storing and releasing catalyst and a particulate filter arranged downstream of the SO_{X} storing and releasing catalyst. SO_{X} release processing is performed for releasing SO_{X} stored in the SO_{X} storing and releasing catalyst. The SO_{X} released by the SO_{X} release processing is supplied to the particulate filter. The larger a time integral showing a sum of products of a temperature of the particulate filter and a time during which it is maintained at that temperature from when SO_{X} release processing was performed, or the greater the number of times the filter regeneration processing is performed, the greater the concentration of SO_{X} released by the SO_{X} release processing.

### CROSS-REFERENCE TO RELATED APPLICATION

This application claims priority based on Japanese Patent Application No. 2017-011308 filed with the Japan Patent Office on Jan. 25, 2017, the entire contents of which are incorporated into the present specification by reference.

### TECHNICAL FIELD

The present disclosure relates to an exhaust purification system for an internal combustion engine.

### BACKGROUND ART

Exhaust contains soot formed at the time of burning fuel and ash formed at the time of burning oil entering into a combustion chamber. In an internal combustion engine provided with a particulate filter, the particulate filter traps this soot and ash. As such a particulate filter, there is known a particulate filter supporting an oxidation catalyst for promoting the action of oxidation of soot at the time of burning the soot.

If processing for regenerating the particulate filter is performed for removing the soot trapped at the particulate filter, the soot is burned away, but the ash remains on the particulate filter without being burned away. In this case, in the case of a particulate filter supporting an oxidation catalyst, this residual ash covers the oxidation catalyst on the particulate filter and, as a result, the action of the oxidation catalyst in oxidizing the soot is obstructed. Therefore, the ash trapped at the particulate filter must be removed.

WO2013/005341A on the other hand discloses an exhaust purification system arranging an SO_{X} storing and releasing catalyst upstream of a particulate filter and making a temperature of the SO_{X} storing and releasing catalyst rise to make the SO_{X} storing and releasing catalyst release SO_{X} when removing ash trapped on the particulate filter and supplying an amount of SO_{X} proportional to the amount of ash to the particulate filter. In this exhaust purification system, the particulate filter does not support an oxidation catalyst. The particulate filter is coated with a solid acid with an acid strength larger than SO₃ and smaller than SO₄. Due to this solid acid, the ash is reduced in size from the submicron order to the nanomicron order and discharged into the atmosphere.

### SUMMARY OF DISCLOSURE

The inventors engaged in intensive research on the ash trapped at a particulate filter and as a result learned that the higher the temperature of a particulate filter and, further, the longer the time during which it is maintained at this temperature, the greater the sticking strength of the ash on the particulate filter. Further, they learned that when the sticking strength of the ash increased, if raising the concentration of the SO_{X} supplied to the particulate filter, it is possible to remove the ash from the particulate filter. However, in the exhaust purification system described in WO2013/005341A, the increase of the sticking strength of the ash is not considered at all. On top of that, the method of removing the ash when the sticking strength of the ash increases is not suggested at all.

### Solution to Problem

The exhaust purification system for an internal combustion engine according to one aspect of the present disclosure comprises an SO_{X} storing and releasing catalyst able to store and release SO_{X} in exhaust discharged from the internal combustion engine, a particulate filter arranged downstream of the SO_{X} storing and releasing catalyst in the direction of flow of exhaust and supporting an oxidation catalyst for trapping soot produced when fuel is burned and ash produced when engine oil is burned, and a control unit configured to be able to perform filter regeneration processing for burning off soot trapped at the particulate filter and SO_{X} release processing for releasing SO_{X} stored at the SO_{X} storing and releasing catalyst, the SO_{X} released by the SO_{X} release processing being supplied to the particulate filter. The control unit is configured to calculate a time integral showing a sum of the products of a temperature of the particulate filter and the time during which it is maintained at that temperature or a number of times the filter regeneration processing is performed. The control unit is configured so that the larger the time integral in the period from when the previous SO_{X} release processing is performed to when the current SO_{X} release processing is performed or the greater the number of times the filter regeneration processing is performed, the more increase the concentration of SO_{X} released from the SO_{X} storing and releasing catalyst when the current SO_{X} release processing is performed.

### Advantageous Effects of Disclosure

The ash trapped on a particulate filter sticks more strongly to the particulate filter the longer the time during which the particulate filter is heated or the higher the temperature to which it is heated. That is, the larger the time integral showing the sum of the products of a temperature of the particulate filter and the time during which it is maintained at that temperature, the more strongly the ash sticks to the particulate filter. In this case, it is learned that if raising the concentration of the SO_{X} supplied to the particulate filter when the sticking strength of the ash increases, it is possible to remove ash from the particulate filter. Therefore, the larger the time integral showing the sum of the products of a temperature of the particulate filter and the time during which it is maintained at that temperature or the greater the number of times the filter regeneration processing is performed, the more it becomes possible to make the concentration of SO_{X} released from the SO_{X} storing and releasing catalyst by the SO_{X} release processing increase to thereby remove the ash from the particulate filter.

### BRIEF DESCRIPTION OF DRAWINGS

FIG. 1 is a schematic view of an exhaust purification system for an internal combustion engine in a first embodiment of the present disclosure.

FIG. 2A and FIG. 2B are a front view of a particulate filter seen from an exhaust inflow end side and a side cross-sectional view of the particulate filter.

FIG. 3A is a view diagrammatically showing an action of ash sticking to a surface of a partition wall of a particulate filter.

FIG. 3B is a view diagrammatically showing an action of ash sticking to a surface of a partition wall of a particulate filter.

FIG. 3C is a view diagrammatically showing an action of ash sticking to a surface of a partition wall of a particulate filter.

FIG. 3D is a view diagrammatically showing an action of ash sticking to a surface of a partition wall of a particulate filter.

FIG. 4 is a view showing a relationship of heating conditions and a sticking ratio of a particulate filter.

FIG. 5 is a view diagrammatically showing a coat layer formed on a surface of a partition wall of a particulate filter.

FIG. 6A is a view diagrammatically showing a catalyst surface of an SO_{X} storage and reduction type catalyst.

FIG. 6B is a view diagrammatically showing a surface of a partition wall of a particulate filter.

FIG. 7 is a view showing a relationship of an operating time of a diesel engine and a SO_{X} release concentration released from an SO_{X} storage and reduction type catalyst.

FIG. 8 is a view showing a relationship of an SO_{X} release concentration and an amount of reduction of thickness of ash.

FIG. 9 is a timing chart of SO_{X} release processing of the first embodiment of the present disclosure.

FIG. 10A is a timing chart of the first embodiment of the present disclosure.

FIG. 10B is a timing chart of the first embodiment of the present disclosure.

FIG. 11A is a timing chart of a second embodiment of the present disclosure.

FIG. 11B is a timing chart of the second embodiment of the present disclosure.

FIG. 12A is a timing chart of SO_{X} release processing of the second embodiment of the present disclosure.

FIG. 12B is a timing chart of SO_{X} release processing of the second embodiment of the present disclosure.

FIG. 13 is a schematic view of an exhaust purification system for an internal combustion engine in a fourth embodiment of the present disclosure.

FIG. 14 is a schematic view of an exhaust purification system for an internal combustion engine in a fifth embodiment of the present disclosure.

FIG. 15 is a flow chart for judging whether to perform SO_{X} release processing in the first embodiment of the present disclosure.

FIG. 16 is a flow chart of SO_{X} release processing in the first embodiment of the present disclosure.

FIG. 17 is a flow chart for judging performance of SO_{X} release processing in the second embodiment of the present disclosure.

FIG. 18 is a flow chart of SO_{X} release processing in a third embodiment of the present disclosure.

FIG. 19 is a flow chart of SO_{X} release processing in the fourth embodiment of the present disclosure.

FIG. 20 is a flow chart of SO_{X} release processing in a fifth embodiment of the present disclosure.

### DESCRIPTION OF EMBODIMENTS

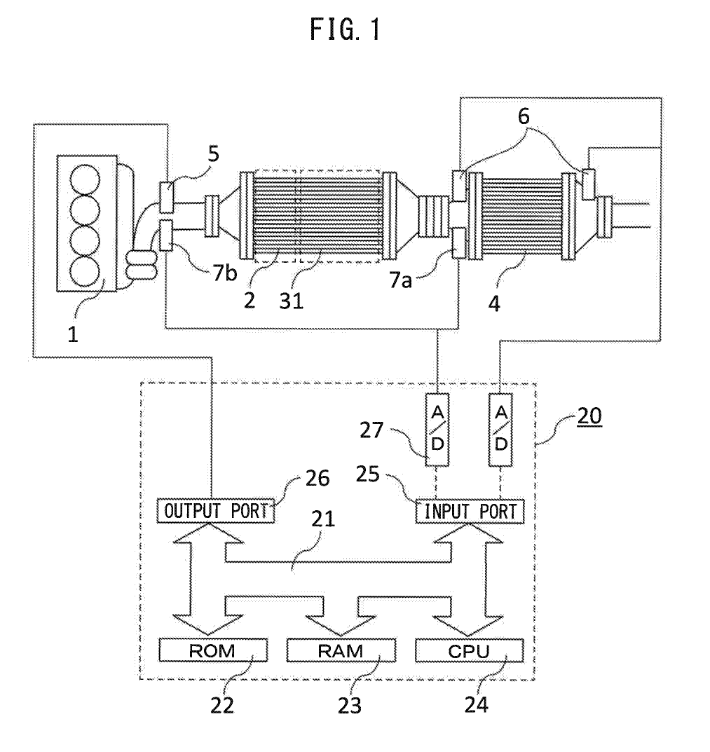

FIG. 1 is a schematic view of an exhaust purification system for an internal combustion engine in a first embodiment of the present disclosure. Referring to FIG. 1, 1 shows a diesel engine, 2 an oxidation catalyst, 31 an SO_{X} storage and reduction type catalyst, 4 a particulate filter, 5 a fuel addition valve, 6 a differential pressure sensor, 7a and 7b temperature sensors, and 20 a control unit.

This control unit 20 is comprised of a digital computer provided with components connected with each other by a bidirectional bus 21 such as a ROM 22, RAM 23, CPU 24, input port 25, and output port 26.

The differential pressure sensor 6 is comprised of a pair of pressure sensors for obtaining a value of differential pressure between upstream and downstream sides of the particulate filter 4. The analog signals output from the pressure sensors are input through corresponding AD converters 27 to the input port 25.

The temperature sensor 7a generates an output voltage proportional to the exhaust temperature near an entrance of the particulate filter 4, while the temperature sensor 7b generates an output voltage proportional to the exhaust temperature near an entrance of the SO_{X} absorption catalyst 31. The output voltages from the temperature sensor 7a and temperature sensor 7b are input through corresponding AD converters 27 to the input port 25. On the other hand, the output port 26 is connected to the fuel injectors of the diesel engine 1, the fuel addition valve 5, etc.

The particulate filter 4 traps ash in addition to soot. In this case, the trapped ash has a large effect on the burning of the soot trapped on the particulate filter 4. Therefore, first, the action of trapping ash will be explained. In the diesel engine 1, normally the engine oil for lubricating the pistons of the diesel engine 1 enter the combustion chambers from between the pistons and cylinders. The engine oil entering the combustion chambers in this way is burned together with the fuel in the combustion chambers whereby ash is produced. This ash is comprised of particulate matter mainly comprised of calcium carbonate or calcium sulfate.

The ash produced in the combustion chambers rides the flow of exhaust and passes through the inside of the oxidation catalyst 2 to reach the SO_{X} storage and reduction type catalyst 31. These oxidation catalyst 2 and SO_{X} storage and reduction type catalyst 31 do not have much of a function of trapping particulate matter, so the majority of the ash slips through the oxidation catalyst 2 and SO_{X} storage and reduction type catalyst 31 without being trapped by the oxidation catalyst 2 and SO_{X} storage and reduction type catalyst 31.

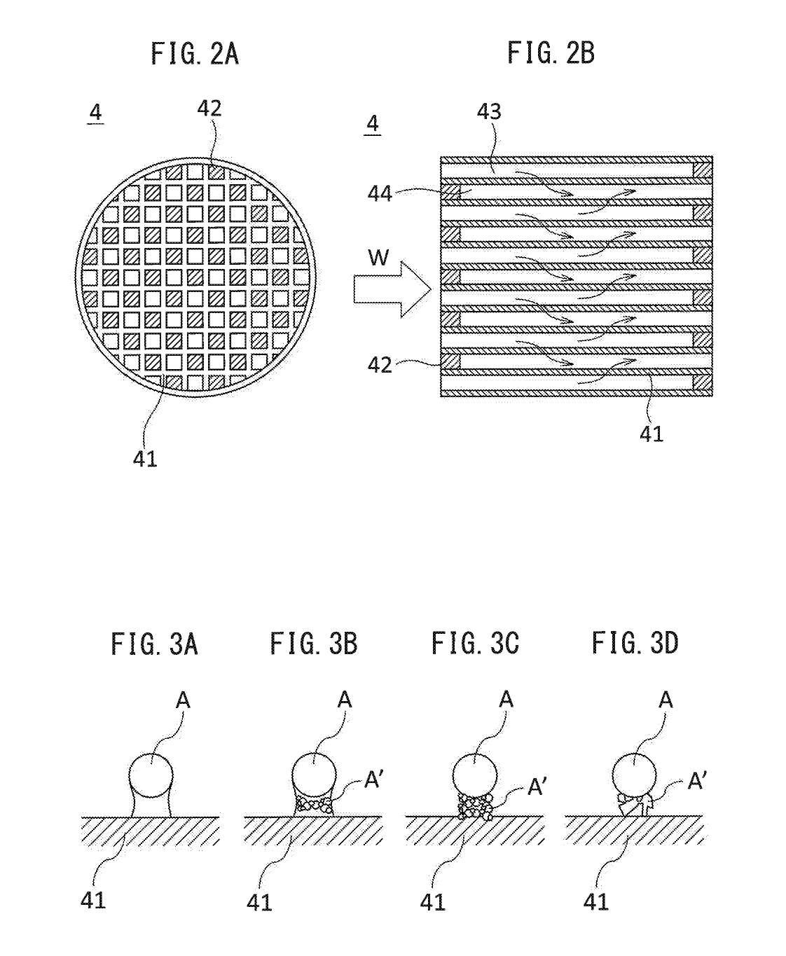

Next, the ash reaches the particulate filter 4 arranged downstream of the SO_{X} storage and reduction type catalyst 31 in the direction of flow of exhaust. Here, referring to FIG. 2A and FIG. 2B, the structure of the particulate filter 4 will be explained. FIG. 2A is a front view of the particulate filter 4 seen from the exhaust inflow end side, while FIG. 2B is a side cross-sectional view of the particulate filter 4 cut along the direction of flow of exhaust.

The particulate filter 4 forms a cylindrical shape having a uniform cross-section over its entire length and extending in the direction of flow of exhaust (arrow W direction of FIG. 2B). At the inside of the particulate filter 4, a plurality of exhaust flow passages surrounded by partition walls 41 are formed. Single ends of the exhaust flow passages in the direction of flow of exhaust, that is, either ends at the exhaust inflow sides or ends at the exhaust outflow sides, are alternately closed by plugs 42. For example, if referring to an exhaust flow passage provided with a plug 42 at the exhaust outflow side end as an “upstream filter passage 43” and an exhaust flow passage provided with a plug 42 at the exhaust inflow side end as a “downstream filter passage 44”, the upstream filter passages 43 and downstream filter passages 44 are arranged adjoining each other. Note that, the inside wall surfaces of the upstream filter passages 43 support an oxidation catalyst.

If exhaust is supplied to such a particulate filter 4, the exhaust first flows to the insides of the upstream filter passages 43. On the other hand, the partition walls 41 separating the upstream filter passages 43 and downstream filter passages 44 are formed from a porous material. Therefore, the exhaust flowing into the upstream filter passages 43 passes through the pores formed in the partition walls 41 and flows out to the insides of the downstream filter passages 44. In this case, soot and ash larger in particle size than the pores formed in the partition walls 41 are trapped by the particulate filter 4 since they cannot pass through the partition walls 41. In this way, particulate matter in the exhaust is removed and the exhaust is purified.

In this regard, the ash trapped on the particulate filter 4 in this way sticks more strongly the longer the time during which the particulate filter 4 is heated or the higher the temperature to which it is heated. FIG. 3A, FIG. 3B, FIG. 3C, and FIG. 3D are views diagrammatically showing the states where ash is stuck to the surfaces of the partition walls 41 of the particulate filter 4.

As shown in FIG. 3A, when the temperature of the particulate filter 4 is close to room temperature, water contained in the exhaust is interposed between the ash A and the partition walls 41. Due to the surface tension of water, the ash A is held at the surfaces of the partition walls 41. If the exhaust flows in this state, as shown in FIG. 3B, the water held between the ash A and the partition walls 41 traps the ash A′ with a particle size smaller than the ash A. As a result, the ash A′ is mixed into the water. In this way, if the particulate filter 4 is heated in the state with ash A′ mixed into the water, as shown in FIG. 3C, the water evaporates and the state becomes one where the ash A and partition walls 41 are stuck to each other through the ash A′.

If the particulate filter 4 is further heated, as shown in FIG. 3D, the ash A′ melts and enters into fine recesses at the surfaces of the partition walls 41. If in such a state the ash A′ further melts and the ash A′ becomes larger in particle size, the surfaces of the partition walls 41 and the ash A are strongly joined. That is, the longer the heating time of the particulate filter 4 or the higher the heating temperature of the particulate filter 4, the more the sticking strength of the ash A to the partition walls 41 is increased. Therefore, the sticking strength of ash can be expressed by the time integral of the products of a temperature of the particulate filter 4 and the time during which it is held at that temperature.

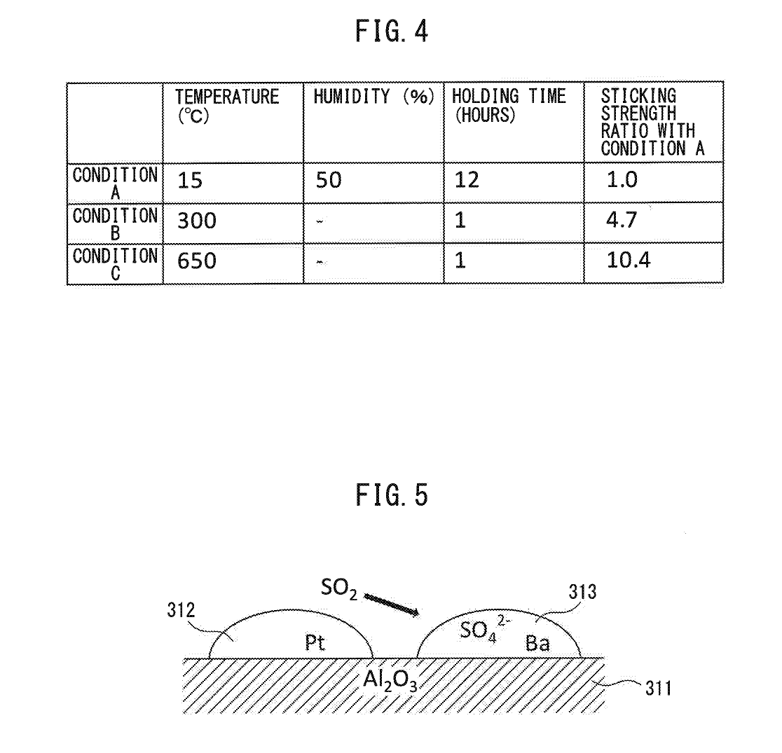

Next, a confirmation test run on the sticking strength of ash to the particulate filter 4 will be explained. The conditions and results of this confirmation test are shown in FIG. 4.

First, particulate filters 4 on which ash was trapped were prepared and the particulate filters 4 were heated while changing the temperature conditions. In FIG. 4, the condition A shows the case of heating a particulate filter 4 at a temperature of 15° C. and a humidity of 50% for 12 hours, the condition B shows the case of heating a particulate filter 4 at a temperature of 300° C. for 1 hour, and the condition C shows the case of heating a particulate filter 4 at a temperature of 650° C. for 1 hour.

On the other hand, the particulate filters 4 were heated under the above conditions, then were measured for the loads required for peeling the ash off the partition walls 41. The measured loads were used as the sticking strengths of the ash.

When defining the sticking strength of the ash under the condition A measured in this way as “1”, the sticking strength of the ash under the condition B was 4.7 and the sticking strength of the ash under the condition C was 10.4. In this way, it will be understood that the higher the temperature of the particulate filter 4 or the longer the heating time of the particulate filter 4, the higher the sticking strength of the ash.

Now, if the particulate filter 4 traps ash in addition to soot, when processing is performed to regenerate the particulate filter 4, the ash remains on the particulate filter 4 without being burned off. This ash covers the oxidation catalyst on the particulate filter 4, so the action of oxidation of the soot by the oxidation catalyst ends up being obstructed. Therefore, the ash trapped on the particulate filter 4 has to be removed. Regarding this, the inventors engaged in repeated experiments and research and as a result learned that this ash can be melted by sulfuric acid, sulfurous acid, or other acid.

That is, ash is mainly comprised of calcium carbonate (CaCO₃) or calcium sulfate (CaSO₄). If sulfuric acid or sulfurous acid acts on ash, part of the ash A′ shown in FIG. 3B to FIG. 3D is melted. As a result, the ash A′ becomes smaller in particle size, so the ash A′ detaches from the partition wall surfaces and, as a result, the sticking strength between the ash A shown in FIG. 3B to FIG. 3D and the partition wall surfaces is lost. It is believed that if sulfuric acid or sulfurous acid is made to act on the ash, the ash will be peeled off from the partition walls 41.

In this case, it is learned that if raising the concentration of sulfuric acid or sulfurous acid supplied to the particulate filter 4 the higher the sticking strength of the ash on the partition walls 41, the ash can be melted more efficiently.

On the other hand, exhaust contains moisture. Therefore, if the exhaust has SO_{X} present in it, sulfuric acid or sulfurous acid is produced. In this case, if raising the concentration of SO_{X} in the exhaust, it is possible to make the concentration of sulfuric acid or sulfurous acid supplied to the particulate filter 4 increase.

Therefore, in one embodiment according to the present disclosure, to supply SO_{X} to the particulate filter 4, an SO_{X} storage and reduction type catalyst 31 for absorbing and releasing SO_{X} is arranged at the upstream side of the particulate filter 4 in the direction of flow of exhaust. This SO_{X} storage and reduction type catalyst 31 can absorb the SO_{X} in the exhaust and can release the SO_{X} into the exhaust by performing SO_{X} release processing for releasing the SO_{X}.

This SO_{X} storage and reduction type catalyst 31 forms a cylindrical shape having a uniform cross-section over its entire length and extending in the direction of flow of exhaust. At the inside of the SO_{X} storage and reduction type catalyst 31, a plurality of exhaust flow passages surrounded by partition walls are formed. Furthermore, the surfaces of the partition walls of the SO_{X} storage and reduction type catalyst 31 are formed with coat layers.

FIG. 5 is a view diagrammatically showing a coat layer formed on a surface of a partition wall. As shown in FIG. 5, for example, a catalyst support 311 comprised of alumina (Al₂O₃) supports a precious metal catalyst 312 and an SO_{X} absorbent 33 for adsorbing SO_{X}.

This precious metal catalyst 312 is selected from at least one of platinum. (Pt), palladium (Pd), and rhodium (Rh). On the other hand, the SO_{X} absorbent 313 has the function of absorbing the SO_{X} oxidized by the precious metal catalyst 312 in the form of sulfuric acid ions. As this SO_{X} absorbent 313, it is possible to use at least one type of metal selected from an alkali metal or alkali earth metal. In the example shown in FIG. 5, barium (Ba) is used as the SO_{X} absorbent 33.

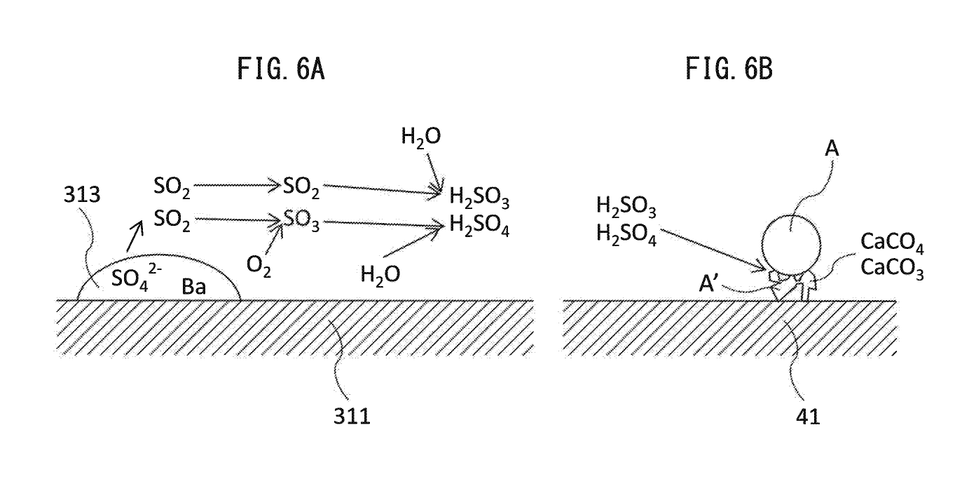

FIG. 6A and FIG. 6B are views diagrammatically showing the action of melting the ash trapped on the partition walls 41 of the particulate filter 4 by the SO_{X} released from the SO_{X} storage and reduction type catalyst 31. Note that, FIG. 6A diagrammatically shows the catalyst surface of the SO_{X} storage and reduction type catalyst 31, while FIG. 6B diagrammatically shows a surface of a partition wall 41 of the particulate filter 4.

If the SO_{X} release processing from the SO_{X} storage and reduction type catalyst 31 is performed, as shown in FIG. 6A, SO_{X} is released from the SO_{X} absorbent 313 in the form of SO₂. Part of this SO₂ reacts with the oxygen in the exhaust to become SO₃. The SO₂ or SO₃ in the exhaust further reacts with the H₂O in the exhaust to become sulfurous acid (H₂SO₃) or sulfuric acid (H₂SO₄). Next, as shown in FIG. 6B, the sulfurous acid or sulfuric acid acts on the ash A′.

In this way, in an embodiment according to the present disclosure, the more the sticking strength between the ash and particulate filter 4 increases, the more the concentration of SO_{X} released from the SO_{X} storing and releasing catalyst 3 is made to increase and, thereby, the more the concentration of sulfuric acid or sulfurous acid supplied to the particulate filter 4 is made to increase. By doing this, it is possible to effectively peel off the ash from the particulate filter 4.

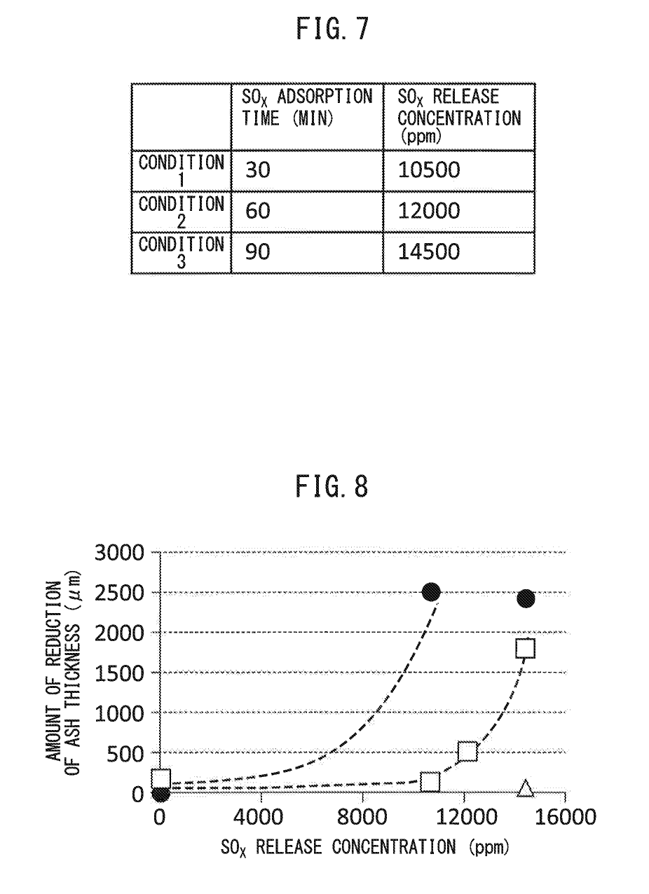

Next, a confirmation test performed for confirming this will be explained while referring to FIG. 7 and FIG. 8. FIG. 7 shows the relationship between an SO_{X} absorption time of the SO_{X} storage and reduction type catalyst 31 and the SO_{X} release concentration of the SO_{X} storage and reduction type catalyst 31.

In this confirmation test, first, gas prepared to contain an SO₂ concentration of 100 ppm, an oxygen concentration of 7%, and a balance of nitrogen was introduced under conditions of a gas temperature of 350° C. and flow rate of 60000 SV/h to a SO_{X} storage and reduction type catalyst 31 for 30 minutes (condition 1 in FIG. 7), 60 minutes (condition 2 in FIG. 7), and 90 minutes (condition 3 in FIG. 7) to make the SO_{X} storage and reduction type catalyst 31 absorb SO_{X}.

Next, gas prepared to contain propane in 1000 ppm, carbon monoxide in 20000 ppm, a carbon dioxide concentration of 7%, and water in 15% was introduced under conditions of a gas temperature of 700° C. and a flow rate of 35000 SV/h to the SO_{X} storage and reduction type catalysts 31. By introducing this gas into the SO_{X} storage and reduction type catalysts 31, the SO_{X} storage and reduction type catalyst was made to release SO_{X}. FIG. 7 shows the SO_{X} release concentration from the SO_{X} storage and reduction type catalyst 31 at this time.

Note that, the SO_{X} release concentration from a SO_{X} storage and reduction type catalyst 31 gradually increases after the SO_{X} release processing is started, becomes the maximum concentration, then gradually decreases. The concentration of SO_{X} shown in FIG. 7 shows the maximum SO_{X} release concentration at this time.

On the other hand, the black dots of FIG. 8 show the amount of reduction of thickness of the ash when making the SO_{X} storage and reduction type catalyst release SO_{X} by the above confirmation test method for the conditions 1 and 3 shown in FIG. 7 using the SO_{X} storage and reduction type catalyst 31 heated under the condition A in FIG. 4, that is, the SO_{X} storage and reduction type catalyst 31 with a weak sticking strength of the ash. On the other hand, the squares of FIG. 8 show the amount of reduction of thickness of the ash when making this SO_{X} storage and reduction type catalyst release SO_{X} by the above confirmation test method for the conditions 1, 2, and 3 shown in FIG. 7 using the SO_{X} storage and reduction type catalyst 31 heated under the condition C in FIG. 4, that is, the SO_{X} storage and reduction type catalyst 31 with a strong sticking strength of the ash.

Note that, the abscissa of FIG. 8 shows the SO_{X} release concentration the same as the SO_{X} release concentration from the SO_{X} storage and reduction type catalyst 31 shown in FIG. 7, while the ordinate of FIG. 8 shows the actually measured value of the amount of decrease of the thickness of the ash on the particulate filter 4 changed due to the SO_{X} released from the SO_{X} storage and reduction type catalyst 31.

As shown by the black dots in FIG. 8, when the sticking strength of the ash was weak, even if the SO_{X} release concentration was 10500 ppm, the amount of reduction of thickness of the ash was extremely large. On the other hand, as shown by the squares in FIG. 8, when the sticking strength of the ash was strong, with an SO_{X} release concentration of 10500 ppm, the thickness of the ash was not reduced much at all and no effect of peeling off the ash could be seen.

However, even when the sticking strength of the ash was strong in this way, if making the SO_{X} release concentration 14500 ppm, the thickness of the ash was greatly reduced and an effect of peeling off the ash was remarkably seen. From this, it can be confirmed that raising the SO_{X} release concentration in accordance with the increase of the sticking strength of the ash is particularly effective for peeling the ash off from the particulate filter.

Note that, in the same way as the case shown by the squares in FIG. 8, the amount of reduction of thickness of the ash when using the particulate filter heated by the condition C in FIG. 4 to prevent the gas from containing H₂O and making the SO_{X} storage and reduction type catalyst release Oₓ by a method similar to the above confirmation test method under the condition 3 shown in FIG. 7 is shown by the triangle in FIG. 8.

From the triangle in FIG. 8, it will be understood that in the state where there is no moisture in the exhaust, the ash cannot be peeled off from the particulate filter. The reason is believed to be that if there is no moisture in the exhaust, no sulfurous acid or sulfuric acid is produced and therefore the ash cannot be melted.

Next, the absorption function and release function of SO_{X} of the SO_{X} storage and reduction type catalyst 31 will be briefly explained.

In the SO_{X} storage and reduction type catalyst 31, when the air-fuel ratio of the inflowing exhaust is lean, as shown in FIG. 5, the SO₂ contained in the exhaust is further oxidized on the surface of the precious metal catalyst 32 to become sulfuric acid ions (SO₄²⁻) then reacts with the SO_{X} absorbent and is absorbed in the form of sulfates inside the SO_{X} absorbent 33. On the other hand, if the air-fuel ratio of the exhaust flowing into the SO_{X} storage and reduction type catalyst 31 is made rich and the temperature of the SO_{X} storage and reduction type catalyst 31 becomes a 600° C. or so SO_{X} release temperature, the reaction proceeds in the reverse direction and the SO₄²⁻ absorbed as sulfate is again released as SO₂.

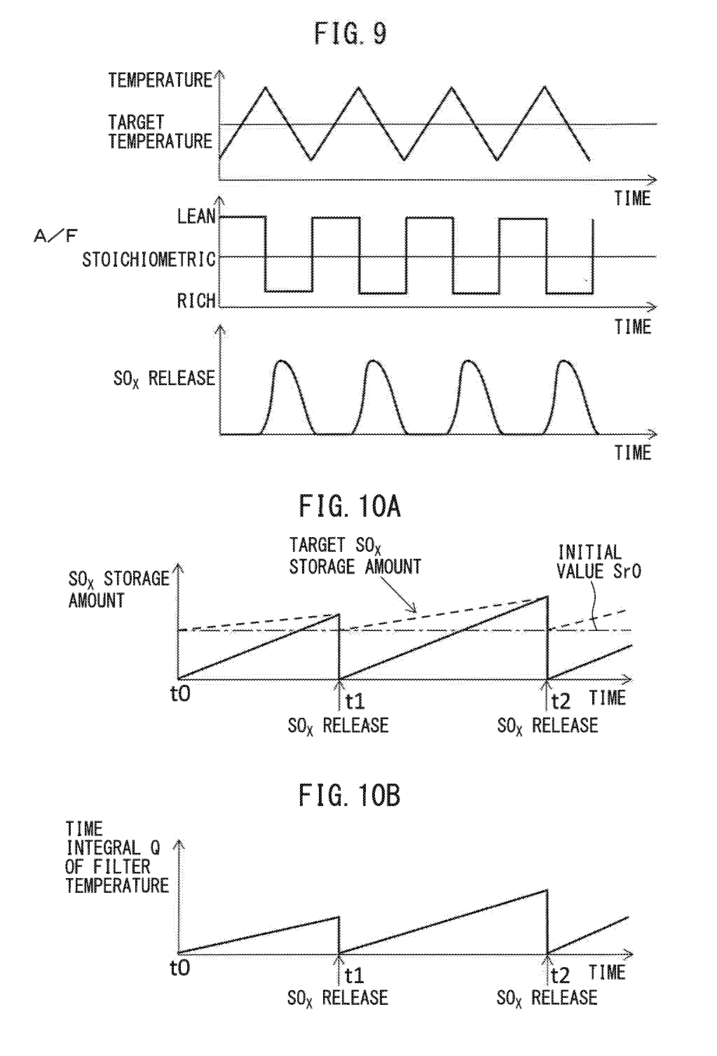

In this way, the following such control is performed to maintain the SO_{X} storage and reduction type catalyst 31 at a high temperature while making the air-fuel ratio of the exhaust rich. FIG. 9 shows a timing chart when performing the SO_{X} release processing.

In this regard, to make the SO_{X} storage and reduction type catalyst 31 release SO_{X}, the temperature of the SO_{X} storage and reduction type catalyst 31 has to be raised to the SO_{X} release temperature. Therefore, in an embodiment according to the present disclosure, if SO_{X} release processing is started, to heat the SO_{X} storage and reduction type catalyst 31, fuel is supplied to the inside of the exhaust pipe from the fuel addition valve 5. If fuel is supplied from the fuel addition valve 5, this fuel is oxidized on the oxidation catalyst 2 and SO_{X} storage and reduction type catalyst 31. Due to the heat of oxidation reaction at this time, the SO_{X} storage and reduction type catalyst 31 is heated.

If the SO_{X} storage and reduction type catalyst 31 is heated and the temperature of the SO_{X} storage and reduction type catalyst 31 exceeds the SO_{X} release temperature, injection control is performed to make the air-fuel ratio of the exhaust rich. At this time, in the embodiment according to the present disclosure, in the injections of fuel in the diesel engine 1, in addition to injection for driving the vehicle (main injection), injection is performed at a timing delayed from the main injection (post-injection) so that the air-fuel ratio of the exhaust is made rich. At this time, a reverse reaction occurs as at the time of absorption of SO_{X}. As shown in FIG. 6A, SO_{X} is released into the exhaust from the SO_{X} storage and reduction type catalyst 31.

Note that, if the air-fuel ratio of the exhaust is made rich by performing post-injection, the post-injected fuel, that is, the hydrocarbon, is cracked in the combustion chambers and the hydrocarbon is supplied to the exhaust pipe in the state of a small molecular weight. As a result, the hydrocarbon becomes higher in reactivity, therefore, the SO_{X} is released well from the SO_{X} storage and reduction type catalyst 31.

On the other hand, when the air-fuel ratio of the exhaust is made rich, no oxidation reaction of the injected fuel occurs, so the temperature of the SO_{X} storage and reduction type catalyst 31 falls. In this case, when the temperature of the SO_{X} storage and reduction type catalyst 31 becomes lower than the SO_{X} release temperature, fuel is injected from the fuel injectors 5 in the state where the air-fuel ratio of the exhaust is made lean. Due to the heat of oxidation reaction of the fuel, the temperature of the SO_{X} storage and reduction type catalyst 31 is made higher than the SO_{X} release temperature.

Therefore, when the temperature of the SO_{X} storage and reduction type catalyst 31 exceeds the SO_{X} release temperature, as shown in FIG. 9, the air-fuel ratio of the exhaust is alternately switched between rich and lean. When the air-fuel ratio of the exhaust becomes rich, SO_{X} is released from the SO_{X} storage and reduction type catalyst 31. At this time, in the example shown in FIG. 9, the rich degree when the air-fuel ratio of the exhaust is made rich is made a predetermined constant value.

Next, the first embodiment of the present disclosure will be explained.

This first embodiment shows the case as shown in FIG. 9 where the rich degree is made a predetermined constant value when the air-fuel ratio of the exhaust for releasing SO_{X} from the SO_{X} storage and reduction type catalyst 31 is made rich.

In this case, when the air-fuel ratio of the exhaust for releasing SO_{X} from the SO_{X} storage and reduction type catalyst 31 is made rich, the greater the SO_{X} storage amount stored in the SO_{X} storage and reduction type catalyst 31, the higher the concentration of SO_{X} released from the SO_{X} storage and reduction type catalyst 31. Therefore, in the first embodiment of the present disclosure, the action of release of SO_{X} from the SO_{X} storage and reduction type catalyst 31 is performed when the stronger the sticking strength of the ash, the greater the SO_{X} storage amount stored in the SO_{X} storage and reduction type catalyst 31.

Specifically, in the first embodiment of the present disclosure, when the SO_{X} storage amount stored in the SO_{X} storage and reduction type catalyst 31 reaches the target SO_{X} storage amount, the action of release of SO_{X} from the SO_{X} storage and reduction type catalyst 31 is performed. This target SO_{X} storage amount is made greater the stronger the sticking strength of the ash. FIG. 10A shows a timing chart of change of the SO_{X} storage amount in the first embodiment.

Next, referring to FIG. 10A, the change of the SO_{X} storage amount of the SO_{X} storage and reduction type catalyst 31 will be explained. Note that, in FIG. 10A, the solid line shows the change in the SO_{X} storage amount, while the broken line shows the change of the target SO_{X} storage amount.

FIG. 10A shows the case where, at the time t0, the action of release of SO_{X} from the SO_{X} storage and reduction type catalyst 31 is performed, next, at the time t1, the SO_{X} release action is again performed, then at the time t2, the SO_{X} release action is again performed.

Note that, fuel contains sulfur in a certain ratio. Therefore, the amount of SO_{X} discharged from an engine can be calculated from the fuel consumption amount. Therefore, the SO_{X} storage amount stored in the SO_{X} storage and reduction type catalyst 31 can also be calculated from the fuel consumption amount. The SO_{X} storage amount shown in FIG. 10A shows this calculated SO_{X} storage amount. The SO_{X} storage amount becomes zero when the SO_{X} release action is performed as shown in FIG. 10A. On the other hand, if the SO_{X} release action ends, along with the elapse of time, the SO_{X} storage and reduction type catalyst 31 stores SO_{X}, so the SO_{X} storage amount gradually increases.

FIG. 10B shows the change in time integral Q of the products of a temperature of the particulate filter 4 and the time during which it is held at that temperature.

As explained above, the sticking strength of ash becomes strong the more this time integral Q increases. On the other hand, to remove the ash built up on the particulate filter 4, the stronger the sticking strength of the ash, the higher the concentration of SO_{X} released from the SO_{X} storage and reduction type catalyst 31 has to be made. In this case, in the first embodiment, to raise the concentration of SO_{X} released from the SO_{X} storage and reduction type catalyst 31, the SO_{X} storage amount when the action of release of SO_{X} from the SO_{X} storage and reduction type catalyst 31 is performed, that is, the target SO_{X} storage amount, has to be increased. That is, in the first embodiment, the more the time integral Q increases, the more the target SO_{X} storage amount must be increased.

On the other hand, to make the ash built up on the particulate filter 4 melt, it is necessary to produce a certain concentration or more of dilute sulfuric acid or sulfuric acid. The broken line in FIG. 10A shows the minimum SO_{X} storage amount Sr0 enabling the production of the minimum concentration of sulfurous acid or sulfuric acid required for making the ash melt. Therefore, as shown in FIG. 10A, the target SO_{X} storage amount is made to increase along with the increase of the time integral Q, with this minimum SO_{X} storage amount Sr0 made the initial value. In this case, the target SO_{X} storage amount is calculated based on the following formula:

Target SO_{X} storage amount=Initial value Sr0+1 of SO_{X} storage amount·time integral Q (1 is a constant)

Note that, in FIG. 10A and FIG. 10B, the case is shown where the temperature of the particulate filter 4 is high from the time t1 to t2 compared with from the time t0 to t1. Therefore, the ratio of increase of the time integral Q of the temperature of the particulate filter 4 from the time t1 to t2 becomes larger than the ratio of increase of the time integral of the temperature of the particulate filter 4 from the time t0 to t1.

As a result, the target SO_{X} storage amount at the time 2 becomes larger than the target SO_{X} storage amount at the time t1. Note that, as explained above, if the SO_{X} storage amount reaches the target SO_{X} storage amount, the action of release of SO_{X} from the SO_{X} storage and reduction type catalyst 31 is performed. At this time, the time integral Q is made zero.

In the above way, according to the first embodiment of the present disclosure, when the SO_{X} storage amount of the SO_{X} storage and reduction type catalyst 31 reaches a predetermined target SO_{X} storage amount, SO_{X} release processing is performed for releasing SO_{X} from the SO_{X} storage and reduction type catalyst 31. The larger the time integral Q of the temperature of the particulate filter 4 cumulatively added from when the SO_{X} release processing ended, the larger the target SO_{X} storage amount is made.

In this first embodiment, by enlarging the target SO_{X} storage amount, it is possible to make a large amount of SO_{X} be released in a short time and, as a result, it is possible to raise the concentration of SO_{X} supplied to the particulate filter 4.

Next, a second embodiment of the present disclosure will be explained. This second embodiment performs the SO_{X} release action from the SO_{X} storage and reduction type catalyst 31 when the target SO_{X} storage amount is made constant and the SO_{X} storage amount reaches the constant target SO_{X} storage amount. In this case, the higher the rich degree when the air-fuel ratio of the exhaust for releasing SO_{X} from the SO_{X} storage and reduction type catalyst 31 is made rich, the higher the concentration of the SO_{X} released from the SO_{X} storage and reduction type catalyst 31.

Therefore, in the second embodiment of the present disclosure, when the action of release of SO_{X} from the SO_{X} storage and reduction type catalyst 31 is performed, the stronger the sticking strength of the ash, the higher the rich degree of the air-fuel ratio of the exhaust is made.

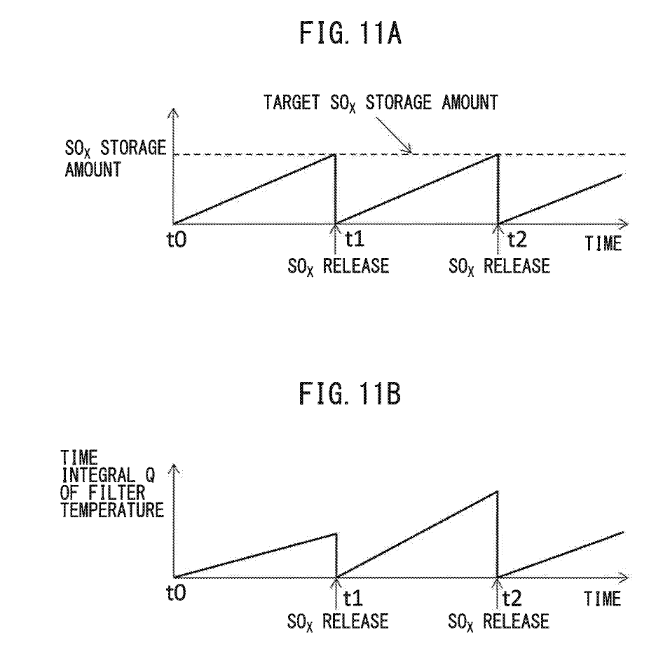

FIG. 11A is a timing chart of change of the SO_{X} storage amount in this second embodiment. Note that, in FIG. 11A, the solid line shows the change in the SO_{X} storage amount, while the broken line shows the target SO_{X} storage amount.

Referring to FIG. 11A, in the same way as the case shown in FIG. 10A, this shows the case where, at the time t0, the action of release of SO_{X} from the SO_{X} storage and reduction type catalyst 31 is performed, next, at the time t1, the SO_{X} release action is again performed, then at the time t2, the SO_{X} release action is again performed.

Note that, the SO_{X} storage amount shown in FIG. 11A, like in FIG. 10A, shows the calculated SO_{X} storage amount. Further, the SO_{X} storage amount becomes zero if the SO_{X} release action is performed. If the SO_{X} release action is completed, along with the elapse of time, the SO_{X} storage and reduction type catalyst 31 stores SO_{X}, so the SO_{X} storage amount gradually increases.

FIG. 11B shows the change in the time integral Q of the products of a temperature of the particulate filter 4 and the time during which it is maintained at that temperature.

As explained above, the sticking strength of the ash becomes stronger the more the time integral Q increases. On the other hand, to remove the ash built up on the particulate filter 4, the stronger the sticking strength of the ash, the higher the concentration of SO_{X} released from the SO_{X} storage and reduction type catalyst 31 must be made. In this case, in the second embodiment, to raise the concentration of SO_{X}, released from the SO_{X} storage and reduction type catalyst 31, it is necessary to raise the rich degree of the air-fuel ratio of the exhaust.

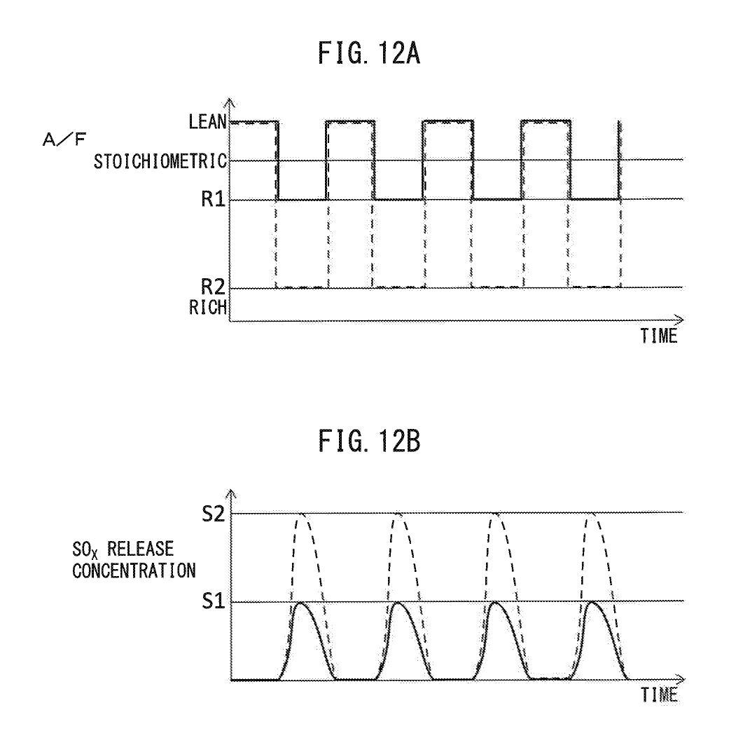

On the other hand, FIG. 12A shows the change in the air-fuel ratio of the exhaust when the action of release of SO_{X} from the SO_{X} storage and reduction type catalyst 31 is performed, while FIG. 12B shows the change in the concentration of SO_{X} released from the SO_{X} storage and reduction type catalyst 31 at this time.

Further, the solid lines in FIG. 12A and FIG. 12B show the case where the time integral Q is small when like at the time t1 of FIG. 11B the action of release of SO_{X} from the SO_{X} storage and reduction type catalyst 31 is performed, while the broken lines in FIG. 12A and FIG. 12B show the case where the time integral Q is large when like at the time t2 of FIG. 11B the action of release of SO_{X} from the SO_{X} storage and reduction type catalyst 31 is performed.

As will be understood from FIG. 12A and FIG. 12B, in this second embodiment, the larger the time integral Q when the action of release of SO_{X} from the SO_{X} storage and reduction type catalyst 31 is performed, the higher the degree of richness of the air-fuel ratio of the exhaust is made. Due to this, the larger the time integral Q, the higher the concentration of release of the SO_{X} released from the SO_{X} storage and reduction type catalyst 31 and, as a result, the more efficiently it is possible to peel off ash from the particulate filter 4.

In the above way, in the second embodiment of the present disclosure, the SO_{X} storing and releasing catalyst 3 is comprised of an SO_{X} storage and reduction type catalyst 31 absorbing SO_{X}, and the SO_{X} release processing for releasing the SO_{X} is performed by making the air-fuel ratio of the exhaust rich. The larger the time integral of the temperature of the particulate filter 4, the larger the rich degree of the air-fuel ratio of the exhaust in the SO_{X} release processing. Due to this, the stronger the sticking strength of the ash, the higher the concentration of the SO_{X} released from the SO_{X} storage and reduction type catalyst 31 can be made.

Next, a third embodiment of the present disclosure will be explained. The third embodiment differs from the first embodiment in the method of estimating the sticking strength of the ash. To explain this third embodiment, control of the particulate filter 4 will first be explained.

As explained above, the particulate filter 4 traps the ash in the exhaust in addition to the soot left over from burning the fuel. If the amount trapped of this soot and ash increases, the particulate filter 4 becomes clogged, the back pressure of the diesel engine 1 is raised, and a drop in the output of the diesel engine 1 is invited. For this reason, when the particulate filter 4 traps a predetermined amount or more of soot and ash, to burn away the soot, the action of heating the particulate filter 4 is performed. In this way, the processing for removing the soot of the particulate filter 4 by heating will be called “filter regeneration processing”.

Every time such filter regeneration processing is performed, the particulate filter 4 is exposed to a high temperature, so the sticking strength of the ash increases. Therefore, in the third embodiment of the present disclosure, the greater the number of times the filter regeneration processing is performed, the more the sticking strength of the ash can be estimated as increasing.

Therefore, in the third embodiment, the number of times the filter regeneration processing is performed is calculated. The larger the number of times the filter regeneration processing is performed, the higher the concentration of SO_{X} is made when the action of release of SO_{X} from the SO_{X} storage and reduction type catalyst 31 is performed. In this case, like in the first embodiment, it is possible to increase the target SO_{X} storage amount so as to raise the concentration of SO_{X} when the SO_{X} release action is performed and, like in the second embodiment, it is possible to increase the rich degree of the air-fuel ratio at the time of SO_{X} release processing so as to raise the concentration of SO_{X} when the SO_{X} release action is performed.

Note that, in general, the frequency of filter regeneration processing is higher than the frequency of SO_{X} release processing. For example, the frequency of filter regeneration processing is once per 200 to 400 km driven by the vehicle, while the SO_{X} release processing is performed once every 1000 to 1500 km driven by the vehicle.

In the above way, according to the third embodiment of the present disclosure, when the soot and ash trapped at the particulate filter 4 reach predetermined amounts, the particulate filter 4 is heated so as to burn off the soot trapped at the particulate filter 4 as filter regeneration processing. The greater the number of times this filter regeneration processing is performed, the greater the target SO_{X} storage amount when the action of release of SO_{X} from the SO_{X} storage and reduction type catalyst 31 is performed. As a result, the stronger the sticking strength of the ash, the higher the concentration of SO_{X} released from the SO_{X} storage and reduction type catalyst 31 can be made and, as a result, the more efficiently the ash stuck to the particulate filter 4 can be removed.

Next, the fourth embodiment of the present disclosure will be explained. This fourth embodiment differs from the first embodiment on the point of provision of an oxygen storing and releasing catalyst 8 for absorbing and releasing oxygen downstream of the SO_{X} storage and reduction type catalyst 31 and the point of provision of an H₂O supply valve 9 for feeding H₂O downstream of the oxygen storing and releasing catalyst 8.

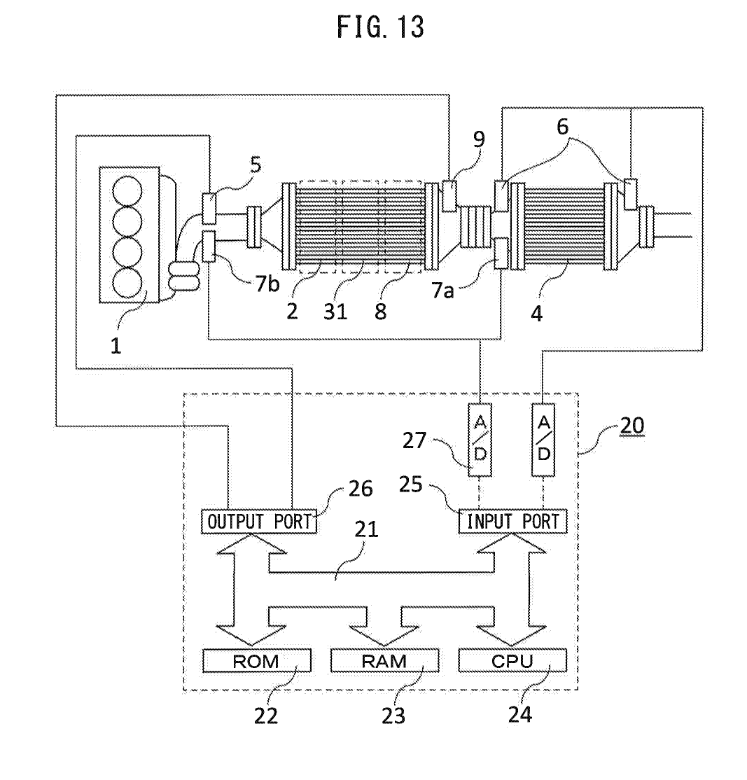

FIG. 13 is a schematic view showing an exhaust purification system for an internal combustion engine for working a fourth embodiment of the present disclosure.

The oxygen storing and releasing catalyst 8 has the property of releasing oxygen when the air-fuel ratio of the exhaust is rich and absorbing oxygen when the air-fuel ratio of the exhaust is lean. The oxygen storing and releasing catalyst 8, like the SO_{X} storage and reduction type catalyst, is formed with a coat layer at the surfaces of the partition walls partitioning the inside of the cylinder. This coat layer contains ceria (CeO₂) as an oxygen absorbing and releasing agent absorbing and releasing oxygen.

Next, the action of the oxygen storing and releasing catalyst 8 when SO_{X} release processing is being performed will be explained.

As explained above, when SO_{X} release processing is being performed, the air-fuel ratio of the exhaust repeatedly becomes rich and lean. In this case, when the air-fuel ratio of the exhaust is rich, SO₂ is released from the SO_{X} storage and reduction type catalyst 31. Next, if the air-fuel ratio of the exhaust becomes lean, part of the SO₂ released from the SO_{X} storage and reduction type catalyst 31 is oxidized and becomes SO₃. Next, if the air-fuel ratio of the exhaust again becomes rich, part of the SO₃ is reduced and returns to SO₂.

In such a case, if an oxygen storing and releasing catalyst 8 is arranged downstream of the SO_{X} storage and reduction type catalyst 31, the oxygen storing and releasing catalyst 8 releases the oxygen adsorbed when the air-fuel ratio of the exhaust was lean when it is rich. For this reason, even if the air-fuel ratio of the exhaust becomes rich, for a while, the air-fuel ratio downstream of the SO_{X} storage and reduction type catalyst 31 in the exhaust is maintained lean. Therefore, downstream of the SO_{X} storage and reduction type catalyst 31 in the exhaust, the time when the SO₃ is reduced to SO₂ becomes shorter and, as a result, the concentration of SO₃ in the exhaust is raised.

If, in this way, the concentration of SO₃ in the exhaust is raised, the concentration of sulfuric acid produced from the SO₃ and H₂O is raised. If in this way the concentration of sulfuric acid is raised, since the reactivity of sulfuric acid is higher than the sulfurous acid produced from the SO₂ and H₂O, it is possible to efficiently melt the ash and possible to efficiently peel off the ash from the particulate filter 4.

In the above way, in the fourth embodiment of the present disclosure, the SO_{X} release processing is processing for making the air-fuel ratio of the exhaust rich so as to make the SO_{X} storage and reduction type catalyst 31 release SO_{X}. Between the SO_{X} storage and reduction type catalyst 31 and the particulate filter 4, an oxygen storing and releasing catalyst 8 is provided for absorbing oxygen when the air-fuel ratio of the exhaust is lean and releasing oxygen when the air-fuel ratio of the exhaust is rich. As a result, due to the oxygen storing and releasing catalyst 8, the concentration of SO₃ in the exhaust rises and the concentration of sulfuric acid rises, so the ash can be efficiently melted and the ash can be efficiently peeled off from the particulate filter 4.

In the fourth embodiment in the present disclosure, further, between the SO_{X} storage and reduction type catalyst 31 and the particulate filter 4, an H₂O supply valve 9 is provided. The H₂O supply valve 9 supplies H₂O to the particulate filter 4 when SO_{X} release processing is performed.

As a result, the SO₂ or SO₃ in the exhaust respectively become sulfurous acid or sulfuric acid due to reaction with the H₂O supplied. The sulfurous acid or sulfuric acid generated in this way can be efficiently melted and the ash can be peeled off from the particulate filter.

Next, the fifth embodiment in the present disclosure will be explained. This fifth embodiment differs from the first embodiment in the point of using an SO_{X} adsorption catalyst 32 able to adsorb the SO_{X} in the exhaust on the surface of the catalyst as the SO_{X} storage and reduction type catalyst 31. This SO_{X} adsorption catalyst 32 is, for example, comprised of an NO adsorption catalyst (Passive NOₓ Adsorber: PNA).

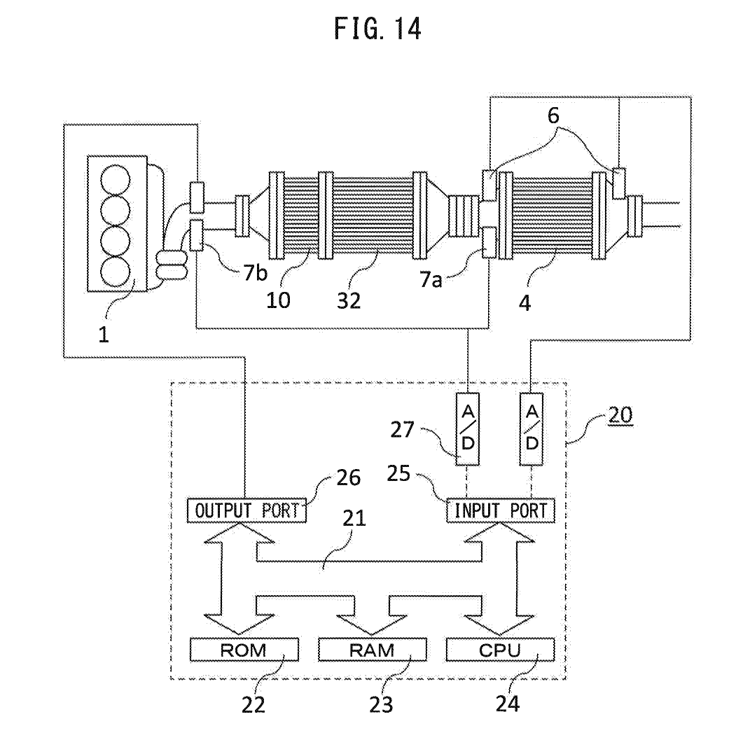

FIG. 14 is a schematic view of an exhaust purification system for an internal combustion engine for working the fifth embodiment. The difference from the exhaust purification system in the second embodiment lies in the point of using a heater 10 instead of the fuel addition valve 5 for heating the exhaust and the point of using the SO_{X} adsorption catalyst 32 instead of the SO_{X} storage and reduction type catalyst 31 for adsorbing and releasing SO_{X}.

Here, an absorption action and adsorption action of SO_{X} will be referred to overall as an SO_{X} storage action. Further, a catalyst having such an SO_{X} storage action will be referred to overall as a SO_{X} storing and releasing catalyst 3. In other words, an SO_{X} storing and releasing catalyst 3 includes both an SO_{X} storage and reduction type catalyst 31 and SO_{X} adsorption catalyst 32.

Next, explaining the SO_{X} adsorption catalyst 32, this SO_{X} adsorption catalyst 32, like the SO_{X} storage and reduction type catalyst 31, has a coat layer formed in the surfaces of the partition walls partitioning the inside of the cylinder. This coat layer contains at least one type of rare earth oxide as an SO_{X} adsorbent having the function of adsorbing the SO_{X}. In the fifth embodiment, the rare earth oxide is comprised of ceria (CeO₂).

Ceria can hold SO₂ at the surface of the ceria by a chemical bonding force if SO₂ in the exhaust is adsorbed at the surface of the ceria. This holding of this SO₂ by adsorption is weaker in force holding the SO₂ compared with holding of SO₂ by the above-mentioned absorption.

For this reason, even when the exhaust is lean, if the temperature of the exhaust becomes high, the thermal motion of the SO₂ becomes higher than the holding force of the SO₂ by ceria. As a result, SO₂ is released into the exhaust.

That is, the SO_{X} adsorption catalyst 32 has the function of adsorbing SO_{X} at a low temperature and releasing SO_{X} at a high temperature.

In this way, in the fifth embodiment, by just heating the SO_{X} adsorption catalyst 32, it is possible to release SO₂ into the air. In other words, in the fifth embodiment, even in the state where the air-fuel ratio of the exhaust is maintained lean, by using the heating device 9 to heat the exhaust, SO₂ is released from the SO_{X} adsorption catalyst 32.

When the air-fuel ratio of the exhaust is lean, that is, when the content of oxygen in the exhaust is large, the SO₂ released into the exhaust is further oxidized and SO₃ is more easily formed. As a result, sulfuric acid is more easily formed and, therefore, the amount of sulfuric acid supplied to the particulate filter 4 increases. Therefore, it is possible to efficiently peel off the ash from the particulate filter 4. Note that, in the fifth embodiment, it is also possible to provide an H₂O supply valve 9 like in the fourth embodiment. By doing this, it is possible to promote the production of sulfuric acid with its high reactivity against the ash and possible to more efficiently peel off the ash.

In this way, in the fifth embodiment in the present disclosure, the SO_{X} storing and releasing catalyst 3 is comprised of an SO_{X} adsorption catalyst 32 including an SO_{X} adsorbent adsorbing SO_{X}. By heating the SO_{X} adsorption catalyst 32 in the state maintaining the air-fuel ratio of the exhaust lean, SO_{X} is released from the SO_{X} adsorption catalyst 32.

By SO_{X} being released as is in a lean atmosphere in this way, the SO₂ is easily oxidized and the concentration of SO₃ in the exhaust increases. As a result, the SO₃ concentration rises and the concentration of sulfuric acid increases, so it is possible to efficiently peel off the ash.

In the above way, in the exhaust purification system of the first to fifth embodiments of the present disclosure, an SO_{X} storing and releasing catalyst 3 able to store and release the SO_{X} in the exhaust discharged from the internal combustion engine is provided. Furthermore, downstream of the SO_{X} storage and reduction type catalyst in the direction of flow of exhaust, a particulate filter 4 is provided for trapping the soot generated by burning fuel and the ash generated by burning engine oil. This particulate filter 4 supports the oxidation catalyst 2. Furthermore, when the soot and ash trapped at the particulate filter 4 reach predetermined amounts, filter regeneration processing is performed for burning off the soot trapped at the particulate filter 4. Further, SO_{X} release processing for making the SO_{X} storing and releasing catalyst 3 release the stored SO_{X} is performed. The SO_{X} released by the SO_{X} release processing is supplied to the particulate filter 4. The time integral showing the sum of the products of a temperature of the particulate filter and time during which it is maintained at that temperature or the number of times filter regeneration processing is performed is calculated. The larger the time integral in the period from when the previous SO_{X} release processing was performed to when the current SO_{X} release processing is performed or the greater the number of times filter regeneration processing is performed, the more the concentration of SO_{X} released by the SO_{X} release processing is increased.

In this exhaust purification system, the larger the time integral of the filter temperature or the greater the number of times regeneration of the filter is performed, that is, the more strongly the ash sticks, the more the concentration of SO_{X} supplied to the particulate filter 4 increases. Due to this, even if the ash strongly sticks, it is possible to reliably peel the ash off the particulate filter 4.

Note that, in the above-mentioned first to fifth embodiments, it is also possible to estimate the state of sticking of the ash by the running distance. That is, the more the running distance increases, the more the amount of soot and ash trapped by the particulate filter 4 increases and the greater the number of times the processing for regeneration of the particulate filter 4 is performed becomes. The more the number of times the filter regeneration processing is performed increases, the more the particulate filter 4 is heated and the more strongly the ash sticks. In this way, it is possible to estimate the state of sticking of the ash from the running distance of the vehicle.

Therefore, the more the running distance of the vehicle from when the previous SO_{X} release processing was performed to when the current SO_{X} release processing is performed increases, the more the concentration of SO_{X} released from the SO_{X} storing and releasing catalyst 3 can be increased.

In this way, in addition, the more the running distance of the vehicle increases, that is, the more the number of times heating of the particulate filter 4 is performed increases, and the more the sticking strength of the ash on the particulate filter 4 increases, the more it is possible to increase the concentration of SO_{X} released from the SO_{X} storage and reduction type catalyst 31. As a result, it is possible to efficiently peel off ash from the particulate filter 4.

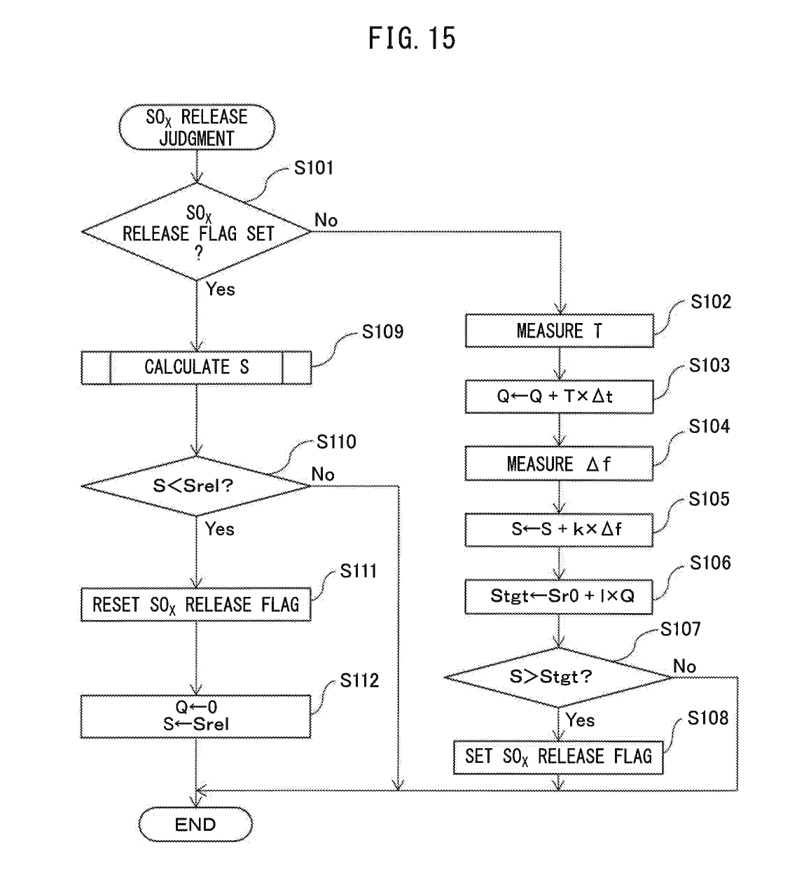

Next, the control for working the embodiments of the first embodiment to the fifth embodiment will be explained while referring to the flow charts. The first embodiment is comprised of two routines. The first routine shown in FIG. 15 judges whether to make SO_{X} be released based on the SO_{X} storage amount stored in the SO_{X} storing and releasing catalyst 3 and controls the amount of SO_{X} to be made to be released based on the heating time or heating temperature of the particulate filter 4.

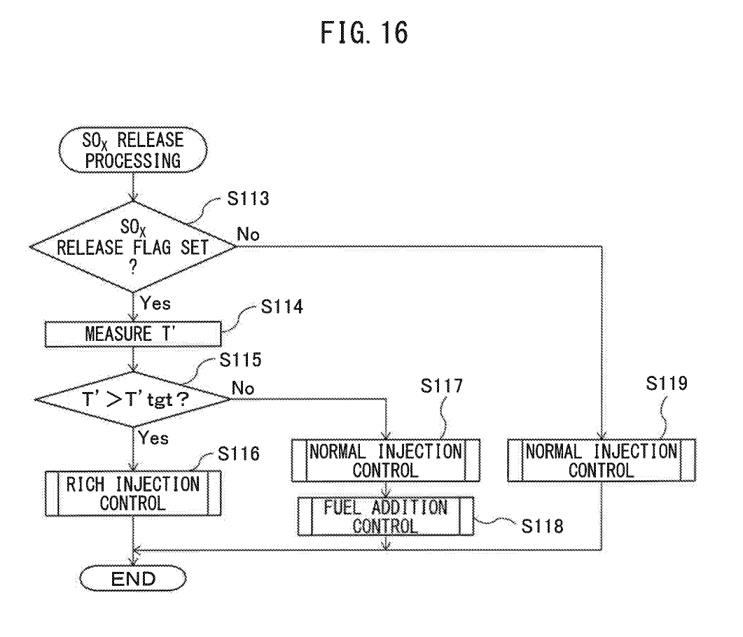

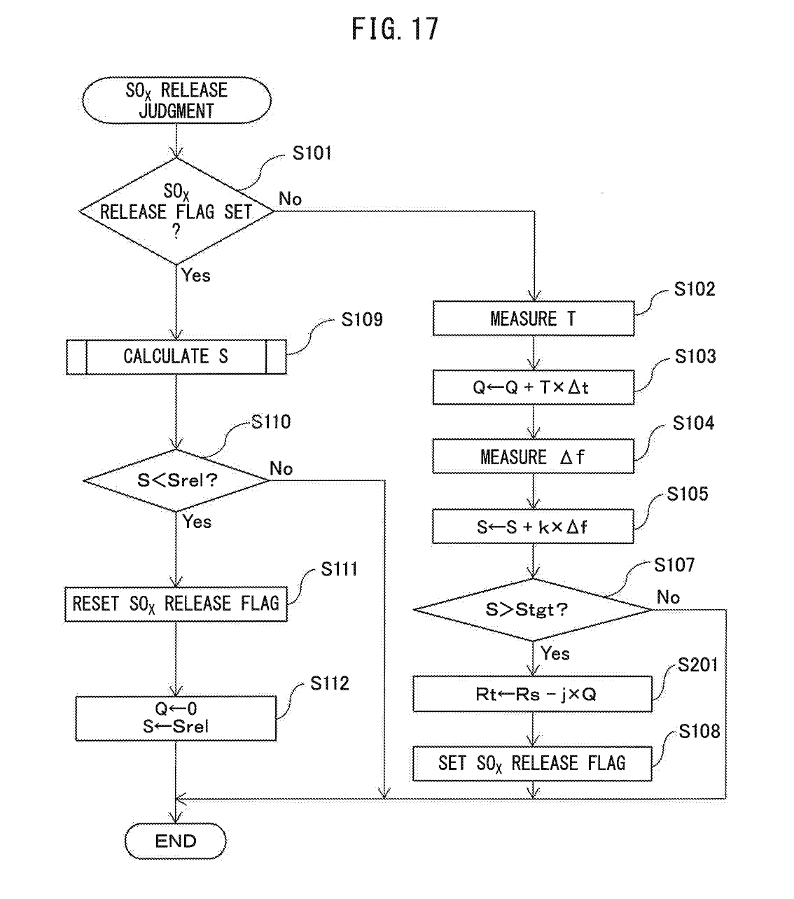

When it is judged by the first routine to make SO_{X} be released, SO_{X} release processing is performed for releasing SO_{X} by the second routine shown in FIG. 16. In the second routine, fuel injection and addition of fuel by the fuel addition valve 5 are controlled based on the temperature of the particulate filter 4.

Note that, in the first embodiment, the target SO_{X} storage amount S for judging whether to release SO_{X} by the first routine is set in accordance with the time integral Q of the temperature of the particulate filter 4. The concentration of SO_{X} supplied to the particulate filter 4 is controlled.

FIG. 15 shows a routine for judging whether to perform the SO_{X} release processing in the first embodiment of the present disclosure. This routine is performed by interruption every certain time Δt.

Referring to FIG. 15, at step S101, it is judged if the SO_{X} release flag to be set during the SO_{X} release processing has been set. When the SO_{X} release flag has been set, the routine proceeds to step S109, while when the SO_{X} release flag has not been set, the routine proceeds to step S102.

At step S102, the exhaust temperature of the entrance of the particulate filter 4 is measured by the temperature sensor 7a shown in FIG. 1. This exhaust temperature is deemed the temperature T of the particulate filter 4.

Next, at step S103, the time integral Q of the filter temperature is calculated by multiplying the interruption time interval Δt of the routine with the temperature T of the particulate filter 4 and adding the product to the time integral Q.

Next, at step S104, the fuel consumption amount Δf consumed during the interruption time Δt of the routine is acquired. The fuel consumption amount Δf is calculated from the fuel injection amount and the air-fuel ratio.

Next, at step S105, the SO_{X} storage amount S stored in the SO_{X} storage and reduction type catalyst 31 is calculated. This SO_{X} storage amount S is proportional to the amount of generation of SO_{X} while the amount of generation of SO_{X} is proportional to the fuel consumption amount, so the SO_{X} storage amount S becomes proportional to the fuel consumption amount Δf. Therefore, at step S105, the SO_{X} storage amount S is calculated by adding the product of the fuel consumption amount Δf and proportional constant k to the SO_{X} storage amount S.

Next, at step S106, the target SO_{X} storage amount for performing the SO_{X} release processing is calculated. The target SO_{X} storage amount Stgt becomes larger the larger the time integral Q of the filter temperature. At step S106, the target SO_{X} storage amount Stgt is calculated by adding the product of the time integral Q of the filter temperature and the coefficient. 1 to the initial value Sr0 of the SO_{X} storage amount shown in FIG. 10.

Next, at step S107, it is judged if the SO_{X} storage amount S calculated at step S106 is larger than the target SO_{X} storage amount Stgt.

If the SO_{X} storage amount S is larger than the target SO_{X} storage amount Stgt, the routine proceeds to step S108, while when the SO_{X} storage amount S is the target SO_{X} storage amount Stgt or less, it is judged that the SO_{X} release processing is unnecessary and the processing routine is ended.

At step S108, the SO_{X} release flag is set. If the SO_{X} release flag is set, while the SO_{X} release flag is being set, SO_{X} release processing is allowed. In this way, the larger the time integral Q of the filter temperature, the larger the target SO_{X} storage amount Stgt is set at step S106, so the larger the time integral Q of the filter temperature, the greater the concentration of SO_{X} when the SO_{X} release processing is started.

If the SO_{X} release flag is set, the routine proceeds from step S101 to step S109. At step S109, the SO_{X} storage amount S during the SO_{X} release processing is calculated. During the SO_{X} release processing, the SO_{X} storage amount S is decreased in accordance with the target air-fuel ratio Rt and temperature and the time elapsed from when the SO_{X} release processing is started. In this case, the amount of decrease of the SO_{X} storage amount per unit time corresponding to the target air-fuel ratio Rt and temperature and the time elapsed from when the SO_{X} release processing is started is found in advance by experiments and stored. Based on this stored SO_{X} storage amount, the SO_{X} storage amount S is calculated.

Next, at step S110, the release target SO_{X} storage amount Srel for ending the SO_{X} release processing and the SO_{X} storage amount S are compared. When the SO_{X} storage amount S is smaller than the release target SO_{X} storage amount Srel, it is judged that SO_{X} has been sufficiently released and the routine proceeds to step S111. On the other hand, when the SO_{X} storage amount S is the release target SO_{X} storage amount Srel or more, it is judged that SO_{X} has not been sufficiently released and the processing cycle is ended. At this time, the SO_{X} release processing flag remains set, so the SO_{X} release processing is continued.

At step S111, the SO_{X} release flag is reset. By the SO_{X} release flag being reset, the SO_{X} release processing being performed in the routine shown in FIG. 16 is stopped.

Next, at step S112, 0 is entered for the time integral Q of the filter temperature and the release target SO_{X} storage amount Srel is entered for the SO_{X} storage amount S, then the processing cycle is ended.

FIG. 16 shows a second routine for performing the SO_{X} release processing in the first embodiment of the present disclosure. This routine is performed by interruption every certain time Δt. It is performed in parallel with the routine for judging whether to perform the SO_{X} release processing shown in FIG. 15.

In the first embodiment of the present disclosure, the amount of release of SO_{X} is controlled by the first routine shown in FIG. 15, so in the second routine, the amount of release of SO_{X} is not controlled. Just the release of SO_{X} is controlled.

Referring to FIG. 16, at step S113, it is judged if the SO_{X} release flag has been set. When the SO_{X} release flag has been set, to perform SO_{X} release processing, the routine proceeds to step S114. As opposed to this, when the SO_{X} release flag has not been set, the routine proceeds to step S119 where normal injection control is performed, then the processing cycle is ended.

On the other hand, at step S114, the temperature of the exhaust T′ is measured by the temperature sensor 7b set near the entrance of the SO_{X} storage and reduction type catalyst 31. This temperature T′ is deemed the temperature of the SO_{X} storage and reduction type catalyst 31.

Next, at step S115, it is judged if the temperature T′ of the SO_{X} storage and reduction type catalyst 31 is higher than the SO_{X} release temperature T′tgt of the SO_{X} storage and reduction type catalyst 31, When the temperature T′ of the SO_{X} storage and reduction type catalyst 31 is higher than the SO_{X} release temperature T′tgt, it is judged that release of SO_{X} is possible. To perform control for making the air-fuel ratio of the exhaust rich, the routine proceeds to step S116. As opposed to this, when the temperature T′ of the SO_{X} storage and reduction type catalyst 31 is lower than the SO_{X} release temperature T′tgt, the routine proceeds to step S117.

Note that, the judgment threshold value of temperature at step S115 may also be lowered to a temperature lower than the SO_{X} release temperature T′tgt (for example 400° C.) For example, when simultaneously releasing NOₓ and releasing SO_{X}, it is also possible to repeat rich control and lean control at a temperature lower than the SO_{X} release temperature T′tgt for releasing NOₓ. In such a case, after repeating rich control and lean control, the temperature of the exhaust becomes higher and has to be controlled until the temperature of the exhaust exceeds the SO_{X} release temperature T′tgt.

At step S116, as shown in FIG. 9, the air-fuel ratio is controlled for alternately making the air-fuel ratio of the exhaust rich and lean. At this time, the fuel injection amount of post-injection is set so that the rich air-fuel ratio becomes the target air-fuel ratio Rt. If the air-fuel ratio of the exhaust is alternately made rich and lean, SO_{X} is released from the SO_{X} storage and reduction type catalyst 31.

On the other hand, when proceeding from step S115 to step S117, the temperature of the SO_{X} storage and reduction type catalyst 31 is insufficient, so at step S117, normal injection control is performed inside the combustion chambers. At this time, the air-fuel ratio of the exhaust becomes lean.

Next, at step S118, fuel is added into the exhaust from the fuel addition valve 5. At this time, since fuel is added from the fuel addition valve 5 in, the state where the air-fuel ratio is maintained lean, the added fuel reacts with the oxygen on the oxidation catalyst 2 and SO_{X} storage and reduction type catalyst 31. Due to the heat of the oxidation reaction at this time, the temperature of the SO_{X} storage and reduction type catalyst 31 is made to rise.

Note that it is also possible to control the air-fuel ratio for making the air-fuel ratio of the exhaust alternately rich and lean at S116, then measure the temperature of the exhaust at S115. In this case, if the temperature of the exhaust is higher than the SO_{X} release temperature T′tgt at S115, the present routine is ended. If the temperature of the exhaust is the SO_{X} release temperature T′tgt or less, the routine proceeds to step S117 where normal injection control is performed and the temperature of the exhaust is raised.

Next, the control of the second embodiment of the present disclosure will be explained. The second embodiment of the present disclosure, in the same way as the first embodiment of the present disclosure, is comprised of a first routine for judging whether to release SO_{X} and a second routine for performing processing for releasing SO_{X}.

The point of difference of the first embodiment and the second embodiment is that in the first embodiment, in the first routine, the target SO_{X} storage amount Stgt is set in accordance with the time integral Q of the filter temperature, while the second embodiment sets the target rich air-fuel ratio at the time of SO_{X} release processing in the first routine in accordance with the time integral Q of the filter temperature. Therefore, below, for the first routine, the point of difference from the first routine in the first embodiment shown in FIG. 15 will be explained, while the second routine is the same as the first embodiment, so the explanation will be omitted.

FIG. 17 shows the first routine for judging whether to perform the SO_{X} release processing in the second embodiment of the present disclosure. This routine is performed by interruption every certain time Δt.

Referring to FIG. 17, when the SO_{X} release processing is not performed, the routine proceeds from step S101 to step S102, then, at step S103, the time integral Q of the filter temperature is calculated. After that, at step S104, the fuel consumption amount ΔF is calculated, while at step S105, the SO_{X} storage amount S is calculated, then the routine proceeds to step S107.

Next, at step S107, it is judged if the SO_{X} storage amount S has exceeded the target SO_{X} storage amount Stgt for judging whether to perform the SO_{X} release processing. In this case, in the second embodiment, as shown in FIG. 11A, this target SO_{X} storage amount Stgt is a constant value. If the SO_{X} storage amount S exceeds the target SO_{X} storage amount Stgt:, it is judged that SO_{X} release processing is necessary and the routine proceeds to step S201. As opposed to this, if the SO_{X} storage amount S is the target SO_{X} storage amount Stgt or less, it is judged that the SO_{X} release processing is not necessary and the processing cycle is ended.

At step S201, the target rich air-fuel ratio Rt showing the rich degree in the SO_{X} release processing is set. In this second embodiment, the target air-fuel ratio Rt is set so that the larger the time integral Q of the filter temperature, the larger the rich degree, that is, the smaller the air-fuel ratio. For example, the target rich air-fuel ratio Rt is obtained by subtracting the product of the time integral Q of the filter temperature and a proportional constant j from the stoichiometric air-fuel ratio Rs. That is, the larger the time integral Q of the filter temperature, the lower the target rich air-fuel ratio Rt is set and the more the concentration of SO_{X} released at the time of release of SO_{X} is made to increase. If the processing of step S201 ends, the routine proceeds to step S108 where the SO_{X} release flag is set, then the processing of the present routine is ended.

In the above way, in the second embodiment of the present disclosure, the larger the time integral Q of the filter temperature due to the first routine, the lower the target rich air-fuel ratio Rt is set. After that, in the second routine, the target rich air-fuel ratio Rt determined by the first routine is used to perform the SO_{X} release processing. At this time, the larger the time integral Q of the filter temperature, the more the SO_{X} release concentration at the time of release of SO_{X} is made to increase.

Next, control of a third embodiment of the present disclosure will be explained. The third embodiment of the present disclosure, in the same way as the first embodiment of the present disclosure, is also comprised of a first routine for judging whether to release SO_{X} and a second routine for performing processing for releasing SO_{X} . The point of difference of the first embodiment and the third embodiment is that, in the first embodiment, the time integral Q of the temperature of the particulate filter 4 in the first routine is used to estimate that sticking of ash has advanced, while in the third embodiment, the greater the number of times the filter regeneration processing is performed in the first routine, the more advance the sticking of ash is estimated. Note that, the second routine is the same as the first embodiment, so the explanation will be omitted.

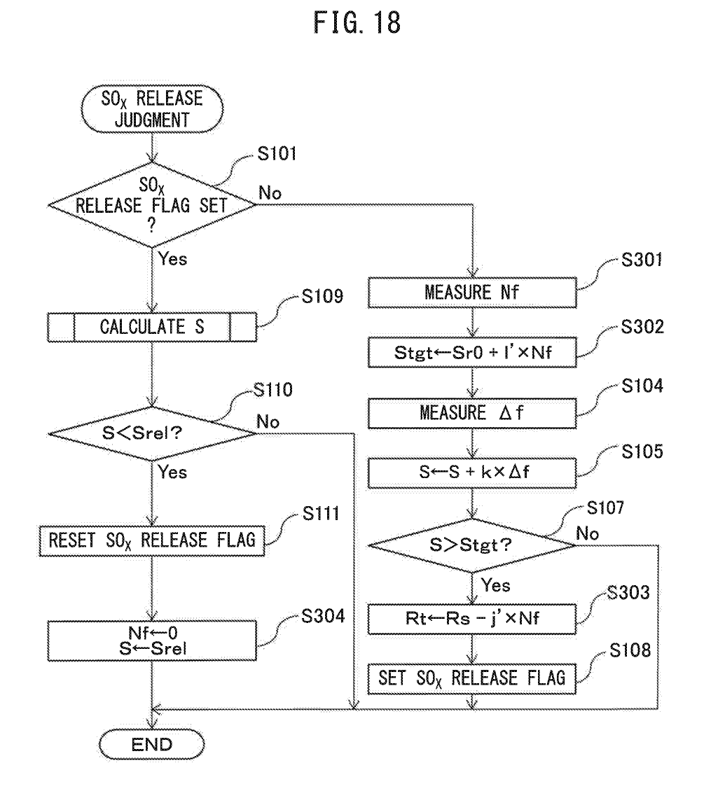

FIG. 18 shows a first routine for judging whether to perform the SO_{X} release processing in the third embodiment of the present disclosure. This routine is performed by interruption every certain time Δt.

Referring to FIG. 18, when the SO_{X} release processing is not being performed, the routine proceeds from step S101 to step S301. At step S301, the number of times Nf the filter regeneration processing is performed is counted. The number of times Nf the filter regeneration processing is performed is incremented each time the filter regeneration processing is performed and is calculated at another routine for handling the filter regeneration processing.

Next, at step S302, the target SO_{X} storage amount Stgt determined for release of SO_{X} is calculated based on the number of times Nf the filter regeneration processing is performed. That is, at step S302, the initial value Sr0 of the target SO_{X} storage amount is increased by the product of the number of times Nf the filter regeneration processing is performed and a coefficient 1′ to calculate the target SO_{X} storage amount Stgt.

Next, after that, at step S104, the fuel consumption amount ΔF is calculated, while at step S105, the SO_{X} storage amount S is calculated, then, at step S107, it is judged that the SO_{X} storage amount has reached the target SO_{X} storage amount Stgt, then the routine proceeds to step S303. At step S303, the target rich air-fuel ratio Rt at the time of the SO_{X} release processing is made smaller the greater the number of times Nf the filter regeneration processing is performed. For example, at step S303, the target rich air-fuel ratio Rt is obtained by subtracting the product of a number of times Nf the filter regeneration processing is performed and the proportional constant j′ from the stoichiometric air-fuel ratio Rs. If the processing of step S303 finishes, at step S108, the SO_{X} release flag is set, then the processing cycle is ended.

If the SO_{X} release flag is set, the routine proceeds from step S101 to step S109 where the SO_{X} storage amount S is calculated. After that, at step S110, when it is judged that the SO_{X} storage amount S has become smaller than the release target SO_{X} storage amount Srel, the routine proceeds to step S111 where the SO_{X} release flag is reset, then, at step S304, the number of times Nf the filter regeneration processing is performed is cleared and the release target SO_{X} storage amount Srel is entered for the SO_{X} storage amount S. As opposed to this, at step S110, when the SO_{X} storage amount S is the release target SO_{X} storage amount Srel or more, the SO_{X} release processing is continued.

In the above way, in this third embodiment, at step S302, the target SO_{X} storage amount Stgt is corrected based on the number of times Nf the filter regeneration processing is performed and, at step S303, the target air-fuel ratio Rt is corrected based on the number of times Nf the filter regeneration processing is performed, whereby the more the number of times Nf the filter regeneration processing is performed is increased, the more the concentration of SO_{X} released at the time of release of SO_{X} can be increased. Note that, in the example shown in FIG. 18, at step S302, the target SO_{X} storage amount Stgt is corrected based on the number of times Nf the filter regeneration processing is performed, while at step S303, the target rich air-fuel ratio Rt is corrected based on the number of times Nf the filter regeneration processing is performed, but it is also possible to correct either of the target SO_{X} storage amount Stgt and the target rich air-fuel ratio Rt based on the number of times Nf the filter regeneration processing is performed.

Next, the control in a fourth embodiment of the present disclosure will be explained. The fourth embodiment of the present disclosure, in the same way as the first embodiment of the present disclosure, is comprised of a first routine for judging whether to release SO_{X} and a second routine for performing processing for releasing SO_{X}. Note that, in the fourth embodiment, the first routine for judging whether to perform the SO_{X} release processing is similar to the first embodiment, so the explanation will be omitted.

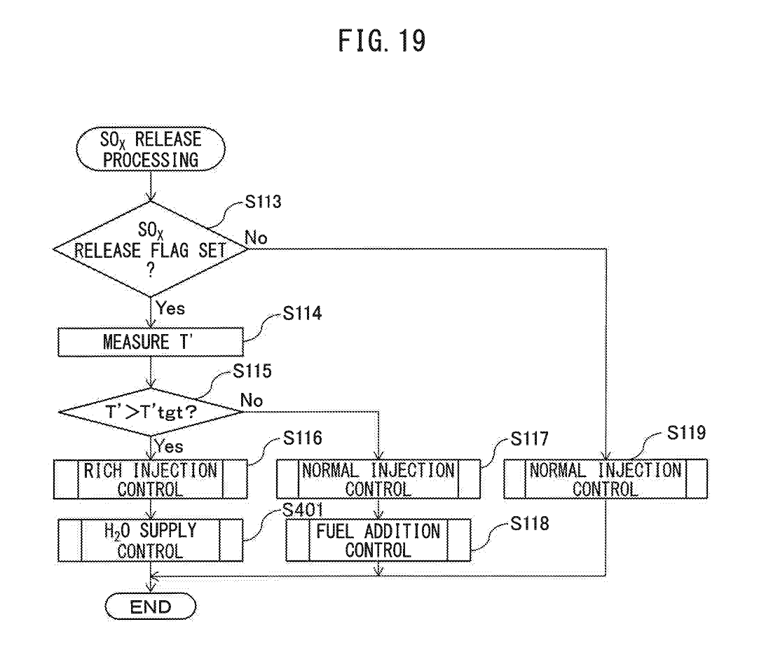

FIG. 19 shows a second routine for performing SO_{X} release processing in the fourth embodiment of the present disclosure. This routine is performed by interruption every certain time Δt.

In this fourth embodiment, unlike the first embodiment, after the rich injection control at step S116, at S401, H₂O is supplied from the H₂O supply valve 9. By H₂O being supplied in this way, the SO₂ or SO₃ in the exhaust reacts with the H₂O to become sulfurous acid or sulfuric acid which is then supplied to the particulate filter 4. As a result, the ash stuck to the particulate filter 4 is peeled off with a good efficiency.

Finally, control for performing a fifth embodiment of the present disclosure will be explained. This fifth embodiment as well, in the same way as the first embodiment of the present disclosure, is comprised of a first routine for judging whether to release SO_{X} and a second routine for performing processing for releasing SO_{X}.

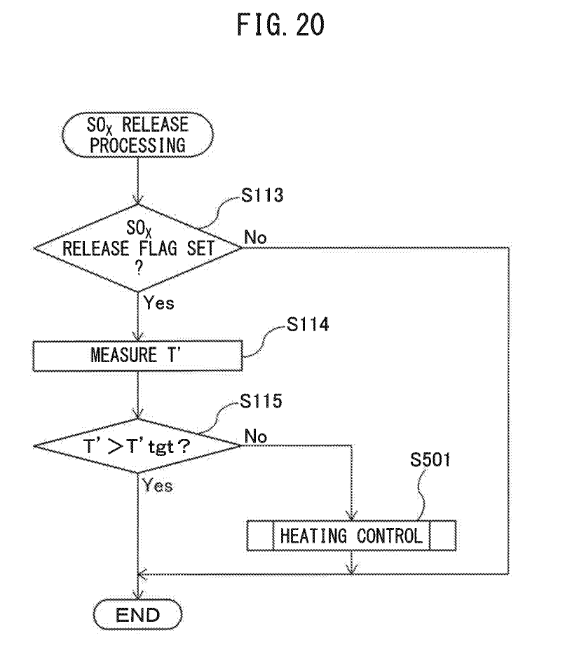

FIG. 20 shows a routine for performing SO_{X} release processing in this fifth embodiment. This routine is performed by interruption every certain time Δt. In this fifth embodiment, unlike the first embodiment, an SO_{X} adsorption catalyst 32 is used. At the time of release of SO_{X}, the temperature of the exhaust is raised in the state maintaining the air-fuel ratio of the exhaust lean. Note that, the routine for judging whether to perform the SO_{X} release processing is similar to the first embodiment, so the explanation will be omitted.

Referring to FIG. 20, first, to start, at step S113, it is judged if the SO_{X} release flag has been set. When the SO_{X} release flag has been set, the routine proceeds to step S114, while when the SO_{X} release flag has not been set, the processing cycle is ended.

At step S114, the temperature of the exhaust T′ is measured by the temperature sensor 7b, next, at step S115, it is judged if the temperature of the exhaust T′ is higher than the target temperature T′tgt. When the temperature of the exhaust T′ is higher than the target temperature T′tgt, it is judged that the state where SO_{X} is being released is maintained and the processing cycle is ended. As opposed to this, when the temperature of the exhaust T′ is lower than the target temperature T′tgt, it is judged that heating is necessary and the routine proceeds to step S501.

At step S501, the exhaust is heated. In this case, in the fifth embodiment, a heater 10 provided upstream of the SO_{X} adsorption catalyst 32 in the direction of flow of exhaust is made to operate so that the exhaust is heated.

1. An exhaust purification system for an internal combustion engine comprising:
an SO_{X} storing and releasing catalyst able to store and release SO_{X} in exhaust discharged from the internal combustion engine;
a particulate filter arranged downstream of the SO_{X} storing and releasing catalyst in the direction of flow of exhaust and supporting an oxidation catalyst for trapping soot produced when fuel is burned and ash produced when engine oil is burned; and
a control unit configured to be able to perform filter regeneration processing for burning off soot trapped at the particulate filter and SO_{X} release processing for releasing SO_{X} stored at the SO_{X} storing and releasing catalyst,
the SO_{X} released by the SO_{X} release processing being supplied to the particulate filter,
in which exhaust purification system for an internal combustion engine,
the control unit is configured:
to calculate a time integral showing a sum of the products of a temperature of the particulate filter and the time during which it is maintained at that temperature or a number of times filter regeneration processing is performed; and
so that the larger the time integral in the period from when the previous SO_{X} release processing is performed to when the current SO_{X} release processing is performed or the greater the number of times the filter regeneration processing is performed, the more increase the concentration of SO_{X} released from the SO_{X} storing and releasing catalyst when the current SO_{X} release processing is performed.

2. The exhaust purification system for an internal combustion engine according to claim 1, wherein
the control unit is configured;
to perform the SO_{X} release processing when the SO_{X} storage amount stored in the SO_{X} stoning and releasing catalyst has reached a predetermined target SO_{X} storage amount; and
so that the larger the time integral, the greater the target SO_{X} storage amount.

3. The exhaust purification system for an internal combustion engine according to claim 1, wherein
the SO_{X} storing and releasing catalyst is comprised of an SO_{X} storage and reduction type catalyst able to absorb SO_{X},
the SO_{X} release processing is processing for making the air-fuel ratio of the exhaust rich to thereby make the SO_{X} storage and reduction type catalyst release SO_{X}, and
the control unit is configured so that the larger the time integral or the greater the number of times the filter regeneration processing is performed, the greater the rich degree of the air-fuel ratio of the exhaust when the SO_{X} is released by the SO_{X} release processing.

4. The exhaust purification system for an internal combustion engine according to claim 1, wherein
the SO_{X} storing and releasing catalyst is comprised of an SO_{X} storage and reduction type catalyst able to absorb SO_{X},
the SO_{X} release processing is processing for making the air-fuel ratio of the exhaust rich to thereby make the SO_{X} storage and reduction type catalyst release SO_{X}, and
the system is provided with an oxygen storing and releasing catalyst for absorbing oxygen when the air-fuel ratio of the exhaust is lean and releasing oxygen when the air-fuel ratio of the exhaust is rich between the SO_{X} storing and releasing catalyst and the particulate filter.

5. The exhaust purification system for an internal combustion engine according to claim 1, wherein
the system is provided with an H₂O feed device between the SO_{X} storing and releasing catalyst and the particulate filter, and
the control unit is configured to control the H₂O feed device to feed H₂O to the particulate filter when performing the SO_{X} release processing.

6. The exhaust purification system for an internal combustion engine according to claim 1, wherein
the SO_{X} storing and releasing catalyst is comprised of an SO_{X} adsorption catalyst containing an SO_{X} adsorbent for adsorbing SO_{X}, and
the SO_{X} release processing is processing for heating the SO_{X} adsorption catalyst in the state where the air-fuel ratio of the exhaust is maintained lean so as to release SO_{X} from the SO_{X} adsorption catalyst.

7. The exhaust purification system for an internal combustion engine according to claim 1, wherein
the control unit is configured so that the greater the running difference of the vehicle increases in the period from when the previous SO_{X} release processing was performed to when the current SO_{X} release processing is performed, the more increase the concentration of SO_{X} released from the SO_{X} storing and releasing catalyst.
